(19) United States
(12) Patent Application Publication
(10) Pub. No.: US 2011/0278765 A1
(43) Pub. Date: Nov. 17, 2011

(54) CONCRETE FORM SYSTEM AND METHOD

(76) Inventor: James Edward RAY, Hopkins, SC (US)

(21) Appl. No.: 12/781,024

(22) Filed: May 17, 2010

(51) Int. Cl. B28B 13/06; B28B 7/16; B28B 7/02; B28B 7/00

(52) U.S. Cl. 264/334; 249/117; 249/143; 249/155

(57) ABSTRACT

A concrete structure kit comprising a dry powdered concrete mixture contained within a shaped container or packaging is provided. In use, the packaged dry concrete mixture is placed in a desired location, water is added to the dry mixture in an appropriate amount, and the concrete is allowed to set in the shape of the container. After the concrete has hardened, the container may be removed from the outside of the concrete structure and discarded. In a second embodiment, a modular concrete mold system is provided, which includes a series of interlocking pieces having various shapes, such as straight sides, curved sides, corners, acute and obtuse angles, and the like. This arrangement allows a user to form a concrete mold into a variety of different shapes, as desired.

### BACKGROUND OF THE INVENTION

The present invention relates generally to methods and systems utilized for forming shaped concrete structures. More specifically, the present invention relates to a method and system whereby a dry concrete powder mixture is packaged in a form having a desired shape, which is then placed in a desired location, and water is added to the mixture, ultimately resulting in a hardened concrete structure. Additionally, a modular concrete form may be used to form desired shapes for the concrete structures.

Concrete (which may be used interchangeably herein with the term cement) is used for creating concrete structures such as paved surfaces, patio slabs, sidewalks, curbs, bases for fence posts and mailboxes, and the like. Concrete slurry is poured into the void or inner cavity created by concrete forms, which may be either permanent or temporary. Permanent forms remain attached to the solidified concrete with the exterior surface of the permanent form creating an edge surface. Temporary forms, in contrast, are removed after the concrete solidifies to reveal a concrete edge. For most home or do-it-yourself jobs, temporary forms are used. For instance, if a person wishes to install a concrete patio at their home, the person would first construct a concrete form, usually out of wood, which is shaped as desired and used to hold the wet concrete in place temporarily until the concrete hardens. Then, the concrete form is removed and discarded. The preparation of the form is a time consuming and expensive process.

Therefore, it would be desirable to provide a system where a dry concrete mixture is packaged in a container having a desired shape, such as a square or rectangular slab, and where the packaging itself serves as the concrete form. In this way, the consumer purchases the dry concrete mixture in the pre-formed packaging, places the item in the desired location, and simply adds water to the concrete mixture. Then, after the concrete is allowed to dry, the packaging may be cut or peeled away from the concrete structure, thereby obviating the steps of building the form and then removing it after drying.

It would also be desirable to provide an alternate embodiment, whereby a modular concrete form is provided so that a user could assemble various components of a form assembly into a desired shape.

### SUMMARY OF THE INVENTION

The present invention includes, in a first embodiment, a concrete structure kit comprising a dry powdered concrete mixture contained within a shaped container or packaging. In use, the packaged concrete mixture is placed in a desired location, water is added to the dry mixture in an appropriate amount, and the concrete is allowed to set in the shape of the packaging. After the concrete has hardened, the packaging may be removed from the outside of the concrete structure. Although prefabricated concrete structures are commercially available, this system has several advantages. One advantage is that the shaped container with a dry powdered cement mixture weighs much less than a corresponding prefabricated concrete structure, thus making transport easier. Additionally, a prefabricated concrete structure may be broken or damaged during transport, while the shaped packaging and dry powdered cement unit is unlikely to be similarly affected.

In a second embodiment, a modular concrete mold system is provided, which includes a series of interlocking pieces having various shapes, such as straight sides, curved sides, corners, acute and obtuse angles, and the like. This system allows a user to construct a concrete form by attaching the shaped components of the modular system, resulting in a concrete form that has a specific, creative, desired shape.

The present invention also includes methods associated with the concrete form systems provided herein.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of a shaped container filled with a dry concrete powder mixture;

FIG. 2 is a perspective view of another embodiment of a shaped container, in this case a cylindrical base for a mailbox post;

FIG. 3 is an exploded view of a modular concrete form; and

FIG. 4 is a perspective view of a modular concrete form.

### DETAILED DESCRIPTION OF THE INVENTION

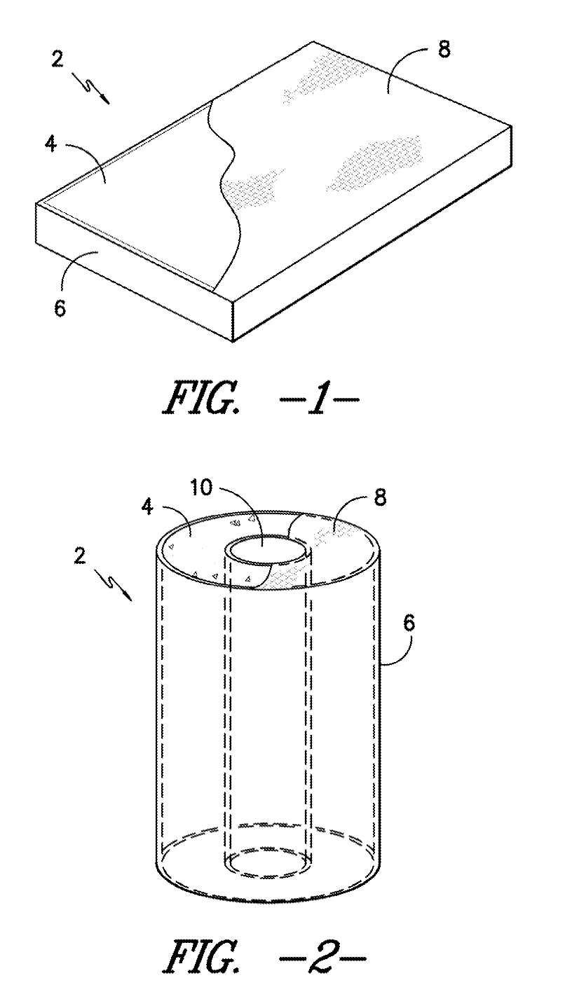

A first embodiment of the concrete form system 2 is shown in FIG. 1. A dry powdered mixture of concrete 4 is contained within a disposable shaped outer shell, container or packaging 6. The container 6 may also include a filter 8 on a top portion thereof, which allows water to pass through, but which prevents the concrete mixture 4 from falling out of the container 6. In this embodiment, the container 6 is placed in a desired location, and then water is added in sufficient quantity to form a slurry within the shaped container 6. Then, the concrete slurry is allowed to set. After the concrete has sufficiently hardened, the container 6 may be cut away or otherwise removed from the concrete structure. The dry powdered concrete mixture 4 may be sold within the shaped container 6 (optionally but preferably including the filter 8 as set forth above) as a kit, which is then used by the consumer to form the final concrete structure.

FIG. 2 shows one example of an application of the concrete form system 2. FIG. 2 illustrates a cylindrical shaped container 6 holding a dry powdered mixture of concrete 4. In its final hardened form, the concrete structure shown in FIG. 2 is a base for a mailbox. A removable dowel 10 (or other article having a desired shape to maintain a hole in the dry concrete powder for a post having a round, square, or other shaped cross-section) is positioned axially within the dry powdered concrete mixture 4, and is used to maintain a hole therein for the ultimate positioning of the mailbox post within the concrete structure. A filter layer 8, which may be made from any suitable fabric or perforated paper, is disposed across the top of the dry concrete powder 4. It is contemplated that a user could purchase the unit shown in FIG. 2. Then, the user would dig a hole in the desired place where he or she would like the mailbox to be located. The container 6 would then be placed into the hole, and the removable dowel 10 is removed. Water is then added to the powdered concrete mixture 4 by pouring or spraying the water preferably through the filter layer 8 (or directly onto the dry powdered concrete mixture 4 if no filter layer 8 is present), thus creating the concrete slurry. The concrete is allowed to set and harden, and then the filter layer 8 (if applicable) and the container 6 may be removed or cut away from the concrete structure.

The shaped container 6 may be made from any suitable material including cardboard or plastic, and may be formed into any desired shape. The dry concrete powder mixture 4 may include other ingredients and aggregates, including fly ash, silica fume, calcinated shale or clay, natural sand, manufactured sand, gravel, light weight aggregates, air entrained additives and blast furnace slag. Any suitable dry concrete powder mixture 4 may be used. Additionally, colors, patterns, or other decorative features may be included; as well, using any known and commercially available colorants, pigments, dyes or techniques.

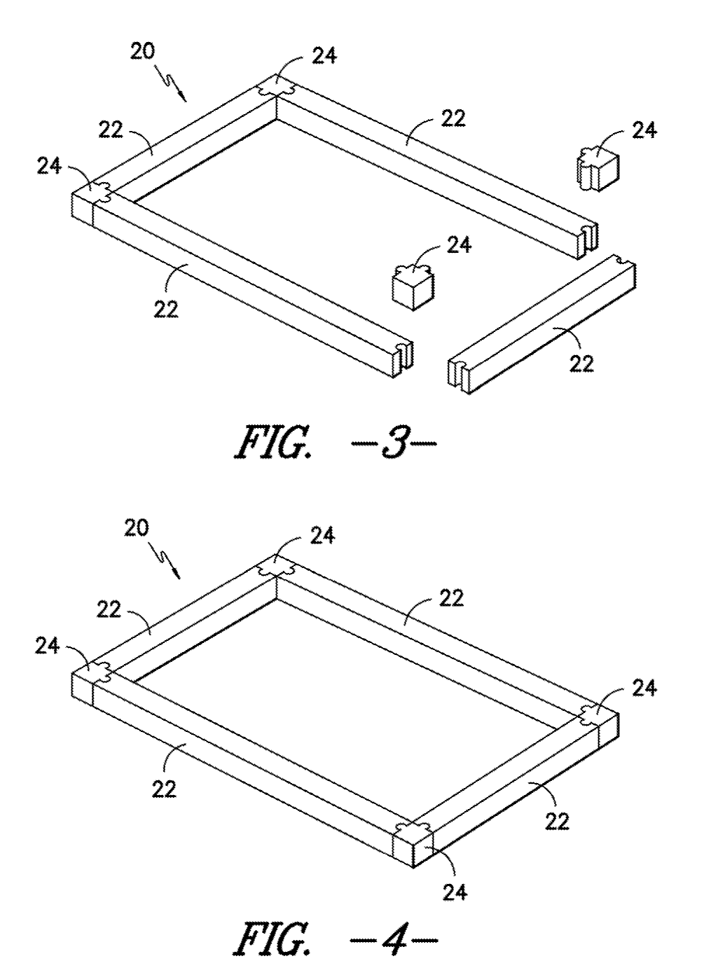

In a second embodiment illustrated in FIGS. 3 and 4, a modular concrete form 20 system is provided, which includes a series of interlocking pieces 22, 24 having various shapes, such as straight sides 22, curved sides, corners 24, acute and obtuse angles, and the like. This system allows a user to construct a concrete form by attaching the shaped components of the modular system 20, resulting in a concrete form that has a specific, creative, desired shape. After the form 20 is constructed, it is placed in a desired location, and then the dry powdered concrete mixture is added to the inside of the form. Water is then added in order to create the slurry. Alternatively, slurry may be added directly to the form 20, rather than mixing the dry concrete powder mixture with the water within the form 20. The concrete slurry is then allowed to set, and when the concrete structure is sufficiently hardened, the modular concrete form 20 may be removed and disassembled. The modular concrete form system may be reused repeatedly. The modular components 22, 24 may be manufactured from any suitable material, although polystyrene is preferred.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A kit for providing a concrete structure, said kit comprising:
a container having a desired shape;
a dry concrete powder mixture disposed within said container;
whereby, an addition of water to said dry concrete mixture within said container creates a slurry and hardens into a concrete structure in said shape of said container, allowing said container to be cut away and removed from said concrete structure.

2. The kit set forth in claim 1, further comprising a filter layer disposed on a top portion of said dry powdered concrete mixture.

3. The kit set forth in claim 2, wherein said filter layer is selected from the group consisting of perforated paper or fabric.

4. The kit set forth in claim 1, wherein said container has a generally cylindrical shape, and which includes an article positioned axially within said dry concrete powder mixture for preserving a hole into which a post may be received.

5. A method of forming a concrete structure, said method comprising the steps of:
providing a shaped container;
filling said shaped container with a dry concrete powder mixture;
adding water to said dry concrete powder mixture within said shaped container to form a slurry;
allowing said slurry to dry and set into a hard concrete structure; and
removing said container from said concrete structure.

6. The method set forth in claim 5, further including the step of:
providing a filter layer disposed above an upper portion of said dry powdered concrete mixture.

7. The method set forth in claim 5, further comprising the step of:
offering for sale and selling said dry powdered concrete mixture within said shaped container.

8. A modular concrete form, said form comprising:
a plurality of interlocking members that may be removably joined together to form a variety of different shapes;
wherein said modular concrete form is adapted to receive an amount of concrete slurry that hardens into a concrete structure having a shape corresponding to a current shape of said modular concrete form;
and wherein said modular concrete form may be disassembled and removed from said concrete structure upon hardening.

9. The modular concrete form set forth in claim 8, further comprising interlocking components selected from the group consisting of: straight edges, curved edges, 90 degree angles, obtuse angles and acute angles.
